(19) United States
(12) Patent Application Publication
(10) Pub. No.: US 2005/0108625 A1
(43) Pub. Date: May 19, 2005

(54) Method and system for selecting rules to validate information submitted on an electronic form

(75) Inventors: Kulvir Singh Bhogal, Fort Worth, TX (US); Daniel Michael Dorrance, Round Rock, TX (US)

Correspondence Address: Darcell Walker, Suite 250, 9301 Southwest Freeway, Houston, TX, 77074, US

(73) Assignee: International Business Machines Corporation, Armonk, NY (US)

(21) Appl. No.: 10/713,734

(22) Filed: Nov. 13, 2003

(51) Int. Cl. G06F 15/00

(52) U.S. Cl. 715/505

(57) ABSTRACT

The present invention provides a method and system for creating a validation rules repository for electronic form validation rules. The software instructions that implement these validation rules would be linked to a record in the repository corresponding to each rule. During the creation of an electronic form on a web page, the software instructions that execute a rule for a particular field on the form would be automatically retrieved from a repository location and installed within the web page. In addition to incorporating existing validation rules, the present invention provides for the creation of new validation rules and storage of these rules in the rules repository.

### FIELD OF THE INVENTION

The present invention relates to a method and system for selecting rules that will validate information entered on an electronic form and more particularly to an improved method and system that will create a repository of electronic form validation rules from which the creator of an electronic form can select rules and corresponding software code to govern the validation of information entered on that form.

### BACKGROUND OF THE INVENTION

Many commercial activities and many private activities usually require some form of written documentation to accurately track the flow of information during that activity. In a commercial transaction, buyers and sellers usually complete several business forms. These business forms contain the information that forms the basis of the relationship between the business entities. Traditionally, the documentation process for transferring information to the forms has been a manual task.

Each business typically has its own unique set of paper service forms, each having a number of relevant fields in which an employee or customer inputs data. As with the collection of any kind of information, certain types, formats, and/or ranges of information are expected for certain fields. For instance, for a delivery tracking activity, a field for “arrival time” must be completed with a time of day, and would be expected to fall during or near normal work hours. When a person completes a paper form, the person must adhere to certain rules or guidelines for filling out the fields. If the rules are followed properly, the forms are correctly filled out and the service provider is given accurate information with which to analyze its business, e.g., modify schedules, dispatch additional workers, etc. Often, however, a person will inadvertently make mistakes when filling out the forms which are only discovered after the form is submitted to a business site (e.g., a dispatch office). By the time the errors are discovered, many hours or even days may have passed, making it difficult to correct the errors and perhaps invalidating any scheduling, shipping or dispatching adjustments previously made based on the incorrect information.

In response to the problems associated with paper forms, more recently, computerized systems have been developed that have replaced the paper forms with electronically stored and implemented forms. Typically, in such systems, a centralized server computer (including all business logic and having access to the necessary databases) communicates via a wireless or other type network with a mobile client computer carried by a worker. Both paper forms and their electronic equivalents have fields for entering data desired for a particular service task, as well as a heading labeling each field and perhaps some instructional information.

In general, an electronic form includes fields for entering data, the heading for each field of the form and any instructional information. In order to ensure the validity of the data entered into the field of the form, some or all of the fields will have an associated validation rule. A validation rule is simply a logical sequence of operators and operands for performing one or more tests or comparisons on data in one or more fields to make sure the data is valid. In the implementation of a particular electronic form, a set of validation rules ensures correct entry of data into the form. The validation rules test the contents of each field entered by the user to ensure that the field is filled out correctly, either after the user enters data into the field, or after the form is transmitted back to a centralized server computer. Either way, errors are caught before the worker leaves the service site.

The World Wide Web (the Web) represents all of the computers on the Internet that offer users access to information on the Internet via interactive documents or Web pages. These Web pages contain hypertext links that are used to connect any combination of graphics, audio, video and text, in a non-linear, non-sequential manner. Hypertext links are created using a special software language known as HyperText Mark-Up Language (HTML).

Once created, Web pages reside on the Web, on Web servers or Web sites. A Web site can contain numerous Web pages. Web client machines running Web browsers can access these Web pages at Web sites via a communications protocol known as HyperText Transport Protocol (HTTP). Web browsers are software interfaces that run on World Wide Web clients to allow access to Web sites via a simple user interface. A Web browser allows a Web client to request a particular Web page from a Web site by specifying a Uniform Resource Locator (URL). A URL is a Web address that identifies the Web page and its location on the Web. When the appropriate Web site receives the URL, the Web page corresponding to the requested URL is located, and if required, HTML output is generated. The HTML output is then sent via HTTP to the client for formatting on the client's screen.

Many people supply information to merchants via a global computing network by inputting this information into an electronic form. One particular type of form relates to a service order or purchase order for a product. If a shopper on the network wanted to place an order for a particular product, a form would appear with blank fields in which the shopper would provide requested information. Once the shopper has finished, the shopper clicks submit to send the page back to the Web server. However, before the page is transmitted back to the web server, JavaScript can be used to power a local validation process to ensure that the information inserted into the page conforms to rules defined by the form creator.

Before any of these activities occur, the electronic forms are created on a web page of a web site. The validation rules that govern the information submitted on the page must be manually coded onto the page. This process is very tedious. Furthermore, many of the validation rules are the same for various types or categories of forms. However, the manual coding of the software is still necessary regardless of the fact that the code already exists at another location. In addition, there is no current method to share code from existing validation rules.

Consequently, there remains a need for a user-friendly, computer-based system and method for quickly and easily creating sets of validation rules. As a result, this new method and system for creating validating rules can substantially shorten the validation rules creation process. The system and method should also be independent of the type or nature of the created electronic form.

### SUMMARY OF THE INVENTION

It is an objective of the present invention to provide a repository for rules that validate information submitted on electronic forms.

It is a second objective of the present invention to provide a link between a validation rule in the repository and software instructions code corresponding to the validation rule.

It is a third objective of the present invention to provide a method for selecting specific validation rules from a rules repository for a desired application.

It is a fourth objective of the present invention to provide a method and system for incorporating a validation rule into an electronic form without the need to manually code the validation software instructions into the electronic form.

It is a fifth objective of the present invention to provide a method to create new validation rules and store these newly created rules in the rules repository.

It is a sixth objective of the present invention to provide a method and system for cataloging the validation rules stored in the repository.

It is a seventh objective of the present invention to provide a method and system for local (client side) validation of electronic form rules.

The present invention provides a method and system for creating a validation rules repository for electronic form validation rules. The software instructions that implement these validation rules would be linked to a record in the repository corresponding to each rule. During the creation of an electronic form on a web page, the software instructions that execute a rule for a particular field on the form would be automatically installed within the web page. This automatic installation is a substantial improvement from the process of manually installing the code for a validation rule each time a form creator desires to use that rule. In addition to incorporating existing validation rules, the present invention provides for the creation of new validation rules and storage of these rules in the rules repository.

In the method of the present invention, the creator of an electronic form will desire information for a particular field on the form. This field could be for example a zip code field. The person supplying the information would enter his/her zip code in that field. The creator desires that the zip code be only five digits in length instead of the nine-digit zip codes. Therefore, the form creator desires to have a form validation rule for the zip code that will enforce this five-digit limitation. In the present invention, the form creator would access the rules repository to retrieve a zip code validation rule that limits the zip code to only five numerical digits. Once in the repository, the creator may desire to view the list of available rules. It is possible that there will be multiple zip code rules from which to select. Another alternative could be for the form creator to enter a description of the rule that the creator wants to implement. With either approach, there is an identification of the specific rule desired for the information on the form. Software code (instructions) that executes the rule is retrieved from a storage location pointed to by information in the pointer field of the selected rule. After the retrieval of the software code, there is an identification of the field in the electronic form for which the selected rule will validate submitted information. In the event that the form creator does not find a desired validation rule in the repository, the present invention provides mechanisms to create new validation rules and store these rules in the rules repository.

### DESCRIPTION OF THE DRAWINGS

FIG. 1 is a conventional computing device that can be used to submit, transmit and receive information electronically via a computing network.

FIG. 2 is a diagram of a computer network over which one can access web pages and transmit information to and retrieve information from a web page via a global computer network.

FIG. 3 is a configuration of an implementation of the present invention.

FIG. 4 is a typical electronic form used to gather information for a specific activity via the global computing network.

FIG. 5 is a general directory of validation rules stored in a repository.

FIG. 6 is a category directory in which certain types of validation rules are grouped together.

FIG. 7 is an individual record for a validation rule stored in the repository.

FIG. 8 is a flow diagram of the general activities in the implementation of the present invention.

FIG. 9 is a flow diagram of the general steps in the implementation of the present invention.

FIG. 10 is a detailed flow diagram of the steps in an embodiment of the present invention.

### DETAILED DESCRIPTION OF THE INVENTION

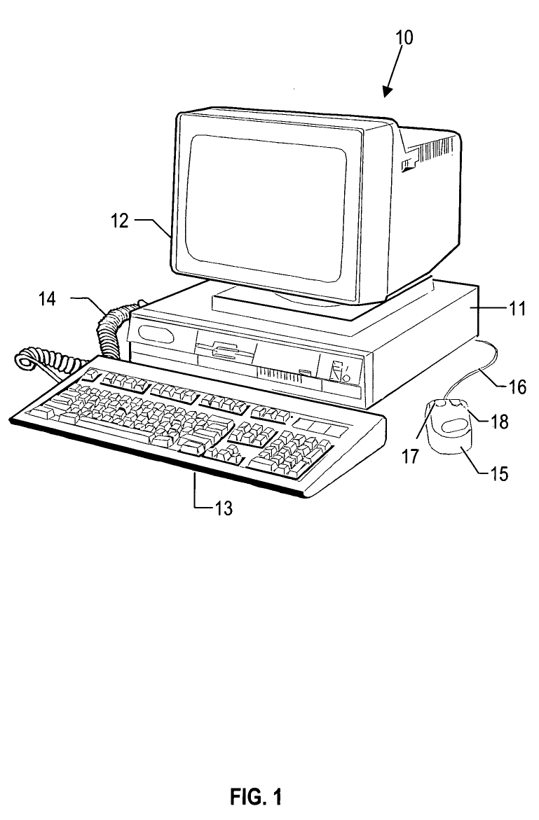

The majority of electronic data transmissions and computerized transactions including completion and transmission of electronic forms occur over computing devices, usually personal computers, connected to a communication network. With reference now to FIG. 1, there is depicted a pictorial representation of computing device 10 which may be used in implementation of the present invention. As may be seen, data processing system 10 includes processor 11 that preferably includes a graphics processor, memory device and central processor (not shown). Coupled to processor 11 is video display 12 which may be implemented utilizing either a color or monochromatic monitor, in a manner well known in the art. Also coupled to processor 11 is keyboard 13. Keyboard 13 preferably comprises a standard computer keyboard, which is coupled to the processor by means of cable 14. Also coupled to processor 11 is a graphical pointing device, such as mouse 15. Mouse 15 is coupled to processor 11, in a manner well known in the art, via cable 16. As is shown, mouse 15 may include left button 17, and right button 18, each of which may be depressed, or “clicked”, to provide command and control signals to data processing system 10. While the disclosed embodiment of the present invention utilizes a mouse, those skilled in the art will appreciate that any graphical pointing device such as a light pen or touch sensitive screen may be utilized to implement the method and apparatus of the present invention. Upon reference to the foregoing, those skilled in the art will appreciate that data processing system 10 may be implemented utilizing a personal computer.

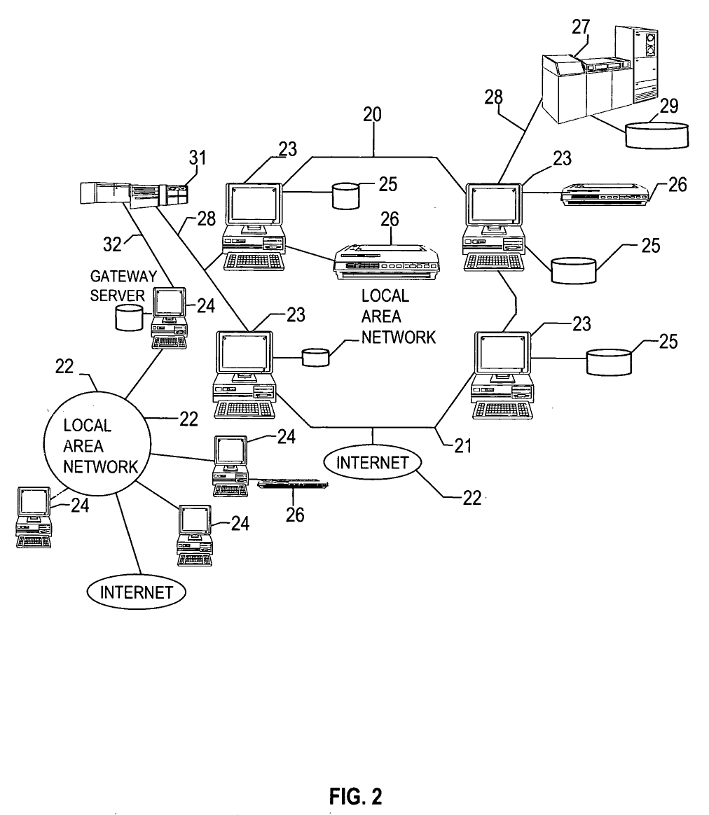

The access to web pages and the transmission of data via web pages usually occurs via a global computer network environment such as the Internet. With reference now FIG. 2, there is depicted a pictorial representation of a distributed computer network environment 20 in which one may implement the method and system of the present invention. As may be seen, distributed data processing system 20 may include a plurality of networks, such as Local Area Networks (LAN) 21 and 22, each of which preferably includes a plurality of individual computers 23 and 24, respectively. Of course, those skilled in the art will appreciate that a plurality of Intelligent Work Stations (IWS) coupled to a host processor may be utilized for each such network. Any of the processing systems may also be connected to the Internet as shown. As is common in such data processing systems, each individual computer may be coupled to a storage device 25 and/or a printer/output device 26. One or more such storage devices 25 may be utilized, in accordance with the method of the present invention, to store the various data objects or documents which may be periodically accessed and processed by a user within distributed data processing system 20, in accordance with the method and system of the present invention. In a manner well known in the prior art, each such data processing procedure or document may be stored within a storage device 25 which is associated with a Resource Manager or Library Service, which is responsible for maintaining and updating all resource objects associated therewith.

Still referring to FIG. 2, it may be seen that distributed data processing system 20 may also include multiple mainframe computers, such as mainframe computer 27, which may be preferably coupled to Local Area Network (LAN) 21 by means of communications link 28. Mainframe computer 27 may also be coupled to a storage device 29 which may serve as remote storage for Local Area Network (LAN) 21. A second Local Area Network (LAN) 22 may be coupled to Local Area Network (LAN) 21 via communications controller 31 and communications link 32 to a gateway server 33. Gateway server 33 is preferably an individual computer or Intelligent Work Station (IWS), which serves to link Local Area Network (LAN) 22 to Local Area Network (LAN) 21.

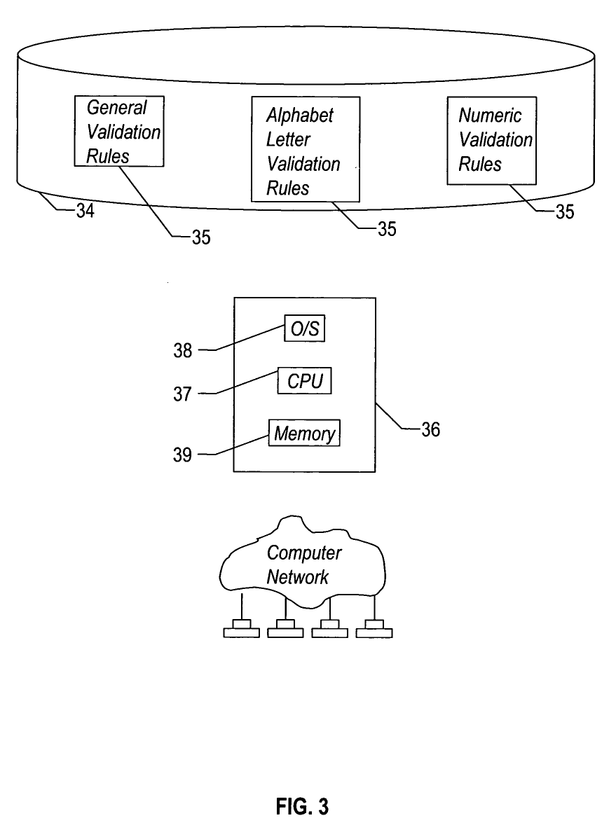

FIG. 3 illustrates a typical configuration of components in the system for implementing the validation rules repository of the present invention. As shown, a validation rules repository 34 contains various existing validation rules 35 that have accumulated over a period of time. The arrangement of these validation rules can be of any currently available database scheme. A conventional method for a user to access the validation rules is from a terminal device 10 connected directly to the rules repository 34. The validation rules repository 34 provides access to these rules. A server device 36 can also connect to the rules repository 36 as shown in FIG. 3. This server device can provide the link to a global computing network 20 such as the Internet. This server 36 can also contain the architecture that controls the maintenance, access and retrieval of the validation rules in the repository 34. As shown, there is a central processing unit 37 that executes retrieved code for various rules from the repository. Operating system programs 38 in the server control the retrieval of and access to the validation rules and associated software code contained in the repository 35. A memory 39 stores these server system programs.

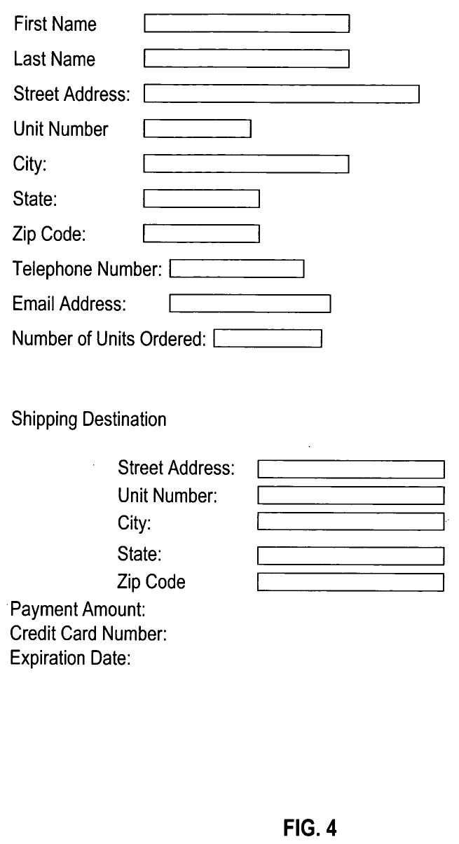

Referring to FIG. 4, shown is a typical electronic form that may appear on a website. In this particular form, a buyer submits information related to the purchase of goods from a manufacturer or merchant. This form has various fields 40. In each field 40, the buyer can submit requested information. In accordance with standard processing procedures for electronic forms, the information supplied in each field is validated at the client location, before actual transmission of the information to server location of the merchant. Each field 40 in the form has a set of one or more rules that validate the information submitted in that field. The information must comply with each rule that governs the particular field. If the information does not comply with a rule, the user will receive an invalid prompt at the time the user submits the form. The invalid prompt usually highlights the field containing the invalid information and gives an explanation for the non-compliance of the information contained in that field. An example of a validation rule for the first two field entries, “First Name and Last Name”, is the requirement that the field can only contain letters of the alphabet. If one of these fields has a character string that contains a character other than letter of the alphabet, the validation rule will detect the invalid character and cause the user to receive an invalid prompt for that field. For the state field 41, there can be a set of two rules: 1) the response must be letters of the alphabet, and 2) the response must specifically contain two letters. In this state field, a response with characters other than letters of the alphabet or a response with less than or more than two letters will generate an invalid response for the state field.

Still referring to FIG. 4, a rule for the zip code field 42 is that the zip code field must be a five-digit or ten-digit numeric response. If the response is a ten-digit response, the sixth character must be a dash character. The telephone number field 43 can have a set of four validation rules: 1) the response can only contain numbers, 2) the response must have twelve and only twelve digits, 3) the fourth and eight characters must be dashes or periods, and 4) the fourth and eighth characters must be the same character. As an option, the fourth and eighth characters can be preset to periods or dashes. For the email address field 44, validation rules could be that the address contain an @ symbol and that the last set characters be a period followed by a two or three-digit suffix. As mentioned, each field in the form will have a set of validation rules to govern information contained in that field.

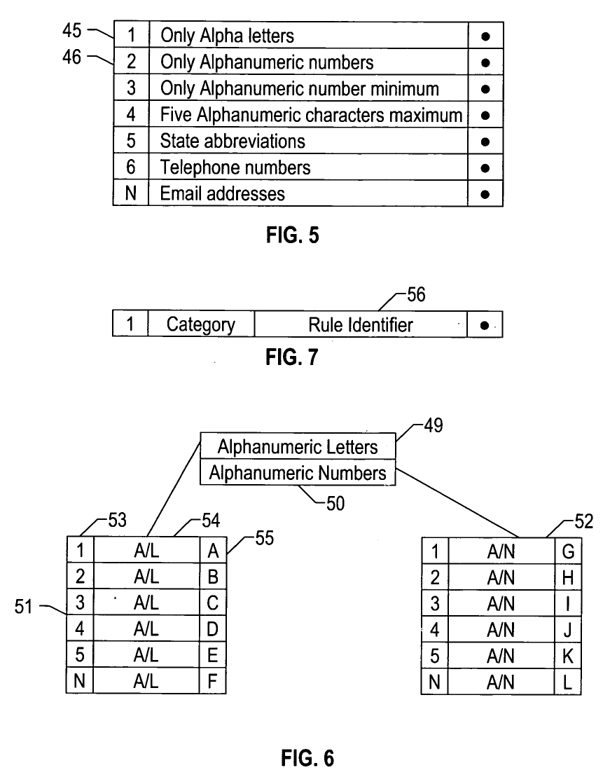

As mentioned, one objective of the present invention is to create a repository for rules that validate information submitted in an electronic or computerized form. FIG. 5 is an illustration of one format for storing the validation rules. In this format, the rules repository contains a record 45 corresponding to each rule. The record, shown in FIG. 5, can be comprised of three fields. However, repository records may contain as many fields as desired or needed based on the format or storage scheme of the repository. Field 46 is a record number field. This field identifies the location (address) of this record in the repository. A rule identifier field 47 gives a description of the kind of rule that is associated with this record. Field 48 is a pointer field that points to a location of the actual software code that will execute the validation process for that rule. The pointer may be needed to link the record to the software code storage location especially if the validation software is in a different location from the rules directory. The repository can have a general directory in which all of the validations rules are listed together and in a numerical order regardless of the type of rule as shown in FIG. 5. Any newly created rule would receive the next number in the list. In the present illustration, the email address rule in record N is the last rule in the repository.

Although FIG. 5 illustrates a general directory for the rules, in many cases the repository may have various sub-directories. Each sub-directory can have a particular type or category of validation rule. FIG. 6 illustrates a sub-directory format for storing rules. Sub-directory 49 can be a set of validation rules for various types of submissions requiring letters of the alphabet. Sub-directory 50 can be a set of validation rules for various types of numerical submissions. Referring back to FIG. 4, the first and last name fields and the state field will require validation rules that relate to alphabet letters. The zip code, telephone, credit card number and expiration date fields relate to numbers. If a user desires to have a validation rule for a field that only requires numbers, i.e. zip code, it may be more efficient to search for a rule in a repository that contains sub-directories. In this manner, the user only needs to search through the numeric sub-directory 50.

In these sub-directories, as shown in FIG. 6, the records 51 and 52 for each sub-directory can be listed in a manner similar to the general directory of FIG. 5. Field 53 is the number or address field of the record in the sub-directory. Field 54 is a rule identifier field that describes the type of validation rule. The type of rule could be for a zip code field or address field. This field 56 or additional field could describe the requirement that the rule enforces, such as only number characters in this field. Field 55 is a previously described pointer field.

Referring to FIG. 7, shown is an alternate validation rule record format 56. This record format also contains an additional field 57 referred to as a category field. The category field can be used to identify certain types or categories of rules during a rules search.

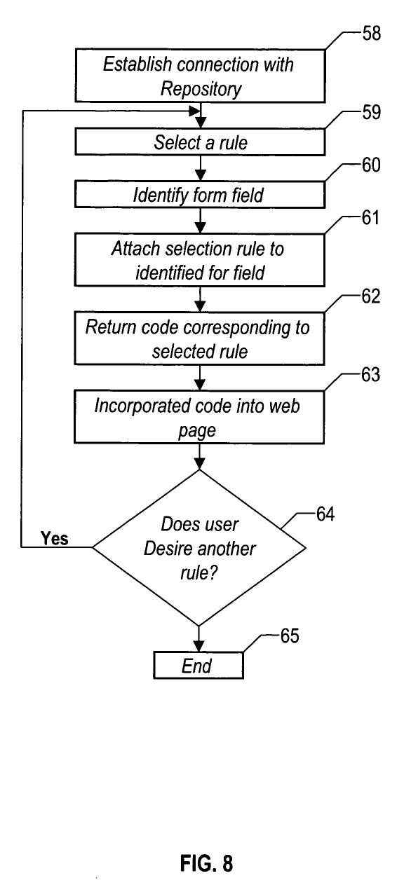

Referring to FIG. 8, shown is a flow diagram of the activities associated with the implementation of the present invention. In step 58, it is necessary to establish a connection with the repository storing the validation rules. After the establishment of the connection to the repository, there can be a display of all of the rules in the repository. In an alternate display method, the display may be of only a category or sub-set of the rules in the repository. This alternate display could be an index listing the various categories of rules from which the electronic form creator (user) can choose. In step 59, the user will view the various rules and select a specific rule for the creator's application. As will be discussed in more detail, this step comprises several activities. In addition, there are optional ways to implement this step. Once the user has selected a validation rule, the user will, in step 60, identify the field in the electronic form for which the selected rule will apply. Referring to the form in FIG. 4, the field may be the zip code field 42. Step 61 attaches the selected rule to the identified field in the form. This attaching process creates a connection or link between the field in the form and the selected rule. At this point, step 62 retrieves the software code for the selected rule. Using the connection link created in step 61, step 63 incorporates the retrieved code into the electronic form such that the code will validate any information contained in the identified field in the electronic form. Because multiple validation rules may govern a form field, at the completion of step 63, the user has the option to select another rule to govern the same form field. Step 64 gives the user this opportunity to select additional rules. In the event, the user does not desire to select another rule, the process ends in step 65. If however, the user does want to select another rule, the process moves back to step 59.

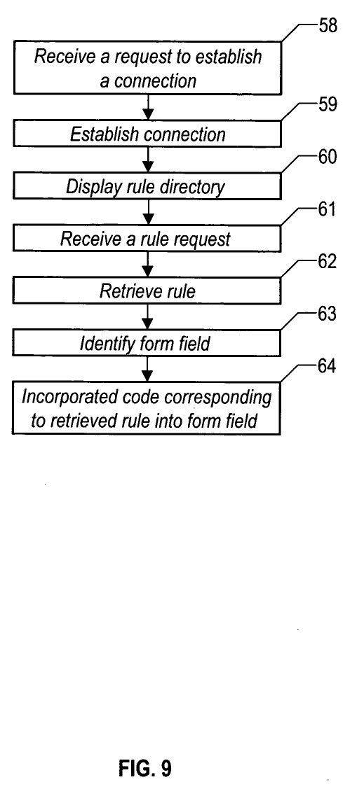

FIG. 9 is a flow diagram of the general steps in the implementation of the method of the present invention. In step 66, the process receives a request to establish a connection with the rules repository. Step 67 establishes this connection through conventional connection procedures. In this embodiment of the invention, the list of rules in the directory is displayed to the requestor/user. The display can be of a general directory containing every rule in the directory or the display can be to a particular sub-directory of rules in the repository. Depending the embodiment, the user may have control over the type of display that is presented in step 68. Once the user has viewed the displayed list of rules, the user can select the desired rule. This selection will be in the form of a rule request. The process of the present invention will receive this rule request in step 69. In step 70, this process retrieves the software code corresponding to the selected rule. In step 71, there is an identification of the form field for which the selected rule will apply. In this step, the process of the present invention can submit a prompt to the user to supply the form field. Depending on the implementation, steps 70 and 71 can occur simultaneously or in reverse order. Once the form field is obtained, the step 72 of the process incorporates/embeds the software code for that rule in the electronic form for that field.

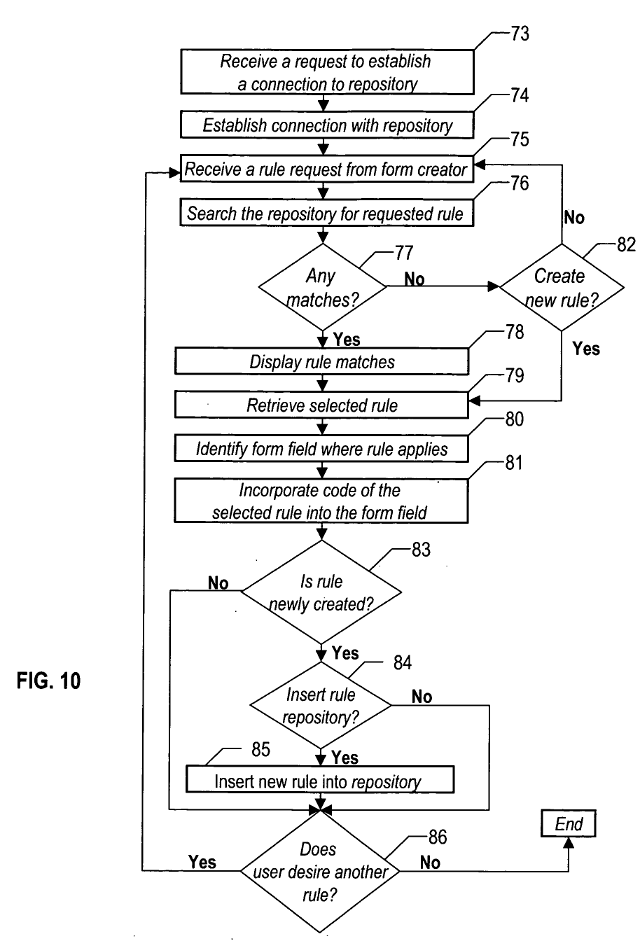

FIG. 10 is a detailed flow diagram of the steps in an embodiment of the present invention. In step 73, the process receives a request to establish a connection with the rules repository. Step 74 can establish this connection through conventional connection procedures. In this embodiment, in step 75 the process receives a rule request. This rule request can be in response to a prompt sent to the user. This rule request response will contain a description of the type of rule desired by the user. This rule request step is different from the rule request process in FIG. 9. In that embodiment, the directory could be automatically displayed at the completion of the establishment of the connection in step 74. These variations demonstrate the flexibility in implementing the present invention.

Step 76 receives the rule request and performs a search of the repository to locate the requested rule. The rule search can be for a particular field within the rule records stored in the repository. In many instances, the search will result in the identification of multiple rules that match a rule request. Step 77 determines whether there are any rules that match the rule request. This determination could be simply counting the number of matches that occur during a particular search. In this case, step 78 displays each rule that matches the request. From the list of matched rules a user can view and select a desired validation rule for a particular application. Once there has been a rule selection, step 79 retrieves the selected rule. Step 80 identifies the form field for which the rule will apply. This form field identification step can involve a query to the user to identify the field and a receipt of the identified form field. Step 81 incorporates/embeds the code corresponding to the selected rule into the form.

Referring back to step 77, if the search of step 76 did not produce a match to the rule request, the process can move to step 82 where the user can have an opportunity to create a new rule for the desired application in step 82. If the user does not want to create a new rule, the user can modify the search request and repeat the search in step 76. However, if the user does desire to create a new rule, the user can do so in step 82. After the completion of the creation of the new rule, the process moves to step 79 and moves through steps 79, 80, and 81.

In step 83, there is a determination of whether the rule incorporated into the form was a rule retrieved from the repository or a newly created rule. If the rule was a newly created rule, the creator has the option to save the rule or not save the rule. Step 84 implements this rule saving option by determining whether the rule creator desires to store this newly created rule in the rules repository. In the implementation of this option, the rule creator can receive a save rule prompt. Upon receiving this prompt, the rule creator can reply with a decision for saving the rule. A newly created rule may be for a unique field and may not have other general uses. In addition, it may not be desirable or necessary to store every created rule in the rules repository. However, if the determination is that the creator wants to store the rule, step 85 inserts the new rule into the rules repository. As part of the insertion process, a record is created for that rule and inserted into the directory. Information received from the user will assist in accurately categorizing the new rule. If the incorporated rule was from the repository, the process skips the save option step 84 and the insertion step 85. In that case, the process then moves to step 86 and determines whether the user desires to retrieve another validation rule for that particular field.

As previously mentioned, in the process of submitting information on an electronic form, a client/user will request a Web page from the Web server. The html is passed back to the user and the form appears to the user. Once the user has completed the form, the user clicks submit to send the page back to the Web server. The browser then runs the (JavaScript) validation process that is embedded inside the web page. This JavaScript program will implement each validation rule designated for each field in the form. This validation process will be local, in that before the page is transmitted back to the web server, the browser executes the validation process to ensure that the information inserted into the page is accurate. The local validation process will be with the rules incorporated into the form in accordance with the steps of the present invention.

Referring to FIG. 10, the present invention provides an additional feature for creating electronic form validation rules. This feature will enable a user to create rules in a manner shown in step 82. With this new rule creation feature, the rule creation process occurs as a separate task and is not part of the method illustrated in FIG. 10. However, similar to steps 83, 84 and 85, this new rule can be inserted into the rules repository. This procedure of creating additional rules outside the creation of an electronic form can be referred to as an add-on procedure.

The concept of the present invention can have numerous implementations and configurations. These implementations would all be within the concept described herein. It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

1. A computer implemented method for selecting rules from a rules repository to validate information submitted on an electronic form comprising the steps of:
a) creating a validation rules repository on a computer;
b) in response to receiving a connection request, establishing a connection with the created rules repository; and
c) in response to receiving a rule request, retrieving the selected rule from the rules repository for incorporation into the electronic form.

2. The method as described in claim 1 further comprising before said retrieving step (c), the step of displaying at least one rule from the rules repository in response to a rule request.

3. The method as described in claim 2 wherein said step (a) further comprises establishing a plurality of categories of rules and storing the rules in the plurality of categories according to rule type.

4. The method as described in claim 3 wherein rule categories comprise alphabet and number categories.

5. The method as described in claim 3 wherein rule types comprise name, zip code, telephone number, city, state and address, and credit card number.

6. The method as described in claim 3 wherein said displaying step further comprises displaying a category of validation rules.

7. The method as described in claim 6 further comprising before said displaying step, the step of receiving the rule request containing an identification of a specific validation rules category.

8. The method as described in claim 7 wherein said displaying step further comprises displaying only rules from the identified validation rules category.

9. The method as described in claim 8 wherein said rule retrieval step further comprises receiving an identification of a rule in the specific validation rules category and retrieving the identified rule from the rules repository.

10. The method as described in claim 1 wherein said step (c) further comprises the steps of:
receiving a description of a desired rule;
searching the repository for rules matching the rule description;
displaying all rules matching the rule description; and
retrieving a rule selected from the displayed rules matching the rule description.

11. The method as described in claim 1 further comprising before said step (c) the steps of:
receiving a validation rule description;
searching the rules repository for rules matching the rule description;
determining whether there are any rules that match the validation rule description;
sending a query to the user to create a new rule when no rule matches the validation rule description; and
retrieving a newly created rule.

12. The method as described in claim 11 further comprising the step of storing the newly created rule in the rule repository.

13. The method as described in claim 1 further comprising after said step (c), the step of incorporating the retrieved rule into the electronic form.

14. The method as described in claim 13 wherein said incorporating step further comprises:
identifying a field in the electronic form;
attaching the selected rule to the identified form field; and
retrieving validation software for the attached rule.

15. A computer implemented method for creating a repository for rules to validate information submitted on an electronic form comprising the steps of:
creating electronic form validation rules;
(a) creating a record for each identified validation rule, the record containing a plurality of fields with information about the rule and a link to software that performs the validation of that rule on information in an electronic form that incorporates that rule;
(b) storing the record for an identified validation rule and the corresponding software for that validation rule in the rule repository; and
(c) repeating the above steps for each newly created rule.

16. The method as described in claim 15 further comprising the step of creating a set of sub-directories in the rule repository, each sub directory would contain at least two categories of validation rules and a plurality of validation rule types under each rule category.

17. The method as described in claim 16 wherein rule types comprise name, zip code, telephone number, city, state and address, and credit card number.

18. The method as described in claim 17 further comprising the step of identifying a rule type for a newly created rule.

19. A system for selecting rules to validate information submitted on an electronic form comprising:
(a) a repository for storing electronic form validation rules;
(b) a computing device connected to said validation rules repository, said computing device capable of interfacing with said repository for the purpose of retrieving form validation rules for incorporation into electronic forms; and
(c) an interface connected to said computing device and said validation rules repository for facilitating communication between said repository and said computing device.

20. The system as described in claim 19 wherein said repository comprises a set validation rule sub-directories in which the rules are stored, said directories being based on categories of validation rules.

21. The system as described in claim 20 wherein each validation rule stored in the repository comprises a record containing a description of the requirement that rule enforces and a pointer to the location in repository of software that executes the validation of that rule on an electronic form.

22. The system as described in claim 19 wherein said interface is a computing network.

23. A computer program product in a computer readable medium for selecting rules from a rules repository to validate information submitted on an electronic form comprising:
a) instructions for creating a validation rules repository on a computer;
b) in response to receiving a connection request, instructions for establishing a connection with the created rules repository; and
c) in response to receiving a rule request, instructions for retrieving the selected rule from the rules repository for incorporation into the electronic form.

24. The computer program product as described in claim 23 further comprising before said retrieving instructions (c), instructions for displaying at least one rule from the rules repository in response to a rule request.

25. The computer program product as described in claim 24 wherein said instructions (a) further comprise instructions for establishing a plurality of categories of rules and instructions for storing the rules in the plurality of categories according to rule type.

26. The computer program product as described in claim 23 wherein said displaying instructions further comprise instructions for displaying a category of validation rules.

27. The computer program product as described in claim 26 further comprising before said displaying instructions, instructions for receiving the rule request containing an identification of a specific validation rules category.

28. The computer program product as described in claim 23 wherein said retrieving instructions (c) further comprise:
instructions for receiving a description of a desired rule, the description containing the rule category;
instructions for searching the repository for rules matching the rule description;
instructions for displaying all rules matching the rule description; and
instructions for retrieving a rule selected from the displayed rules matching the rule description.

29. The computer program product as described in claim 23 further comprising before said retrieving instructions (c):
instructions for receiving a validation rule descriptor;
instructions for searching the rules repository for rules matching the rule description;
instructions for determining whether there are any rules that match the validation rule description;
instructions sending a query to the user to create a new rule when no rule matches the validation rule descriptor; and
instructions retrieving a newly created rule.

30. The computer program product as described in claim 23 further comprising after said retrieving instructions (c), instructions for incorporating the retrieved rule into the electronic form.

31. The computer program product as described in claim 30 wherein said incorporating instructions further comprise:
instructions for identifying a field in the electronic form;
instructions for attaching the selected rule to the identified form field; and
instructions for retrieving validation software for the attached rule.
